(19) United States
(12) Patent Application Publication
(10) Pub. No.: US 2004/0072585 A1
(43) Pub. Date: Apr. 15, 2004

(54) Method of sending an sms type message and a corresponding radio-communication terminal

(76) Inventors: Minh Le, Paris (FR); Frederic Lejay, Paris (FR)

Correspondence Address: SUGHRUE MION, PLLC, 2100 PENNSYLVANIA AVENUE, N.W., SUITE 800, WASHINGTON, DC, 20037, US

(21) Appl. No.: 10/468,294

(22) PCT Filed: Jan. 14, 2003
(86) PCT No.: PCT/FR03/00093

(30) Foreign Application Priority Data
Jan. 21, 2002 (FR) 02/00695

(51) Int. Cl. H04Q 7/20

(52) U.S. Cl. 455/466; 455/412.1; 455/550.1

(57) ABSTRACT

The invention relates to a method of sending a message, such as an SMS message comprising an address field, from a first radio terminal to a recipient radio terminal, the address field of said SMS message being filled in with the number of the recipient terminal, which method is characterized in that said recipient terminal number is selected from numbers stored automatically in the first terminal, said stored numbers consisting of the numbers of the last few caller and/or called terminals.

The invention relates to a method of sending an SMS message including an address field by a user of a radio terminal, to a recipient also equipped with a radio terminal.

The field of the invention is that of radio communication with mobiles and more particularly the Short Message Service (SMS). An SMS message is a short text message exchanged between two persons each equipped with a radio terminal such as a mobile telephone. The invention can also encompass Enhanced Message Service (EMS) messages whose architecture is identical to that of SMS messages and enables the sending of pictures, tunes or more extensive texts, and Multimedia Message Service (MMS) messages.

For simplicity, the remainder of the description relates only to SMS messages.

Like the other message architectures just mentioned, an SMS message includes at least one field relating to the address of the recipient of the message and one field relating to the text of the message.

At present, when the user of a radio terminal wishes to send an SMS message, the service is offered via a menu that is displayed on the display screen of his mobile telephone, for example in the following manner.

The home page of the menu offers a choice between, for example:

access directory

access messages

etc

The user selecting “access messages” calls up the following display:

read messages

create a message

etc

The user choosing “create a message” calls up the following display:

enter text

send to

confirm sending

etc

The user choosing “send to” calls up the following display:

one recipient

a group of recipients

a recipient from the directory.

The user may sometimes wish to send an SMS message during a voice call; in particular, he may wish to send one to the person with whom he is in radio communication.

At present, if the called party wishes to send an SMS message to the other party (the calling party), for example, he enters the text of the message and generally proceeds in the following manner to fill in the address field. He scrolls through the directory of his mobile telephone; if the number of the other party is there, he imports it into the SMS message as the address of the SMS message; if not, he asks the other party for his number and enters it on his mobile telephone, to store it as the address of the SMS message.

These operations are irksome and mistakes can occur when entering the number.

The user proceeds in the same manner and therefore suffers the same drawbacks if he is in a meeting, for example, and, being unable to respond to a call, wishes to send an SMS message to the person who has just attempted to call him.

The document US 2001/0028709 discloses a method of sending an SMS message more easily to the person who has attempted to call when it is not possible or desirable to take the call. The user enters a command on his keypad to choose and send a predetermined SMS message. The message is chosen from a set of predetermined messages stored in the terminal. The user does not have to find out the number of the recipient. The terminal identifies the person attempting to call from the caller identification data accompanying the last call received and automatically sends the SMS message to that number.

The object of the present invention is to facilitate sending SMS messages, in particular in situations where the recipient is not the last caller, or when a call is already set up, without suffering the drawbacks of the conventional procedures: choosing an SMS message recipient number from the whole of the directory, or manual entry of a number.

The invention consists in a method of sending a message, such as an SMS message comprising an address field, from a first radio terminal to a recipient radio terminal, the address field of said SMS message being filled in with the number of the recipient terminal, which method is characterized in that the first terminal automatically prompts its user to choose said recipient terminal number from an ordered list of numbers stored automatically in the first terminal, said stored numbers consisting of the numbers of the last few caller and/or called terminals, and in that the recipient terminal number is chosen from the ordered list by a user of said first terminal using said control means.

In one application, the first recipient terminal number in the ordered list is that of a terminal with which the first terminal is in radio communication.

The invention also provides a radio terminal including means for sending an SMS message comprising an address field and at least one memory area adapted to store the numbers of the last few caller and/or called radio terminals, which terminal is characterized in that said means for sending an SMS message include:

means for ordering a list of recipient terminal numbers from numbers stored automatically in said memory area,

means for prompting its user to choose said recipient terminal number from said ordered list, and

means for commanding the copying of the selected number from said memory area into said address field.

According to an additional feature, the radio terminal includes configuration parameters, at least one of which is dedicated to copying the number into the address field, and means for configuring said parameter with a view to said copying.

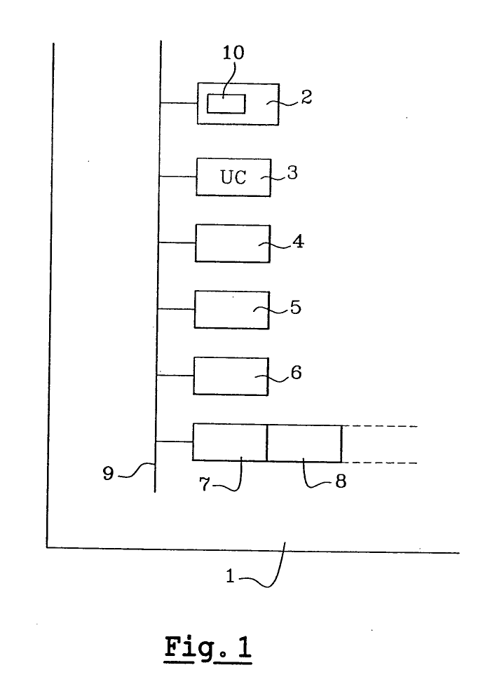

Other features and advantages of the invention will become more clearly apparent on reading the following description, which is given by way of nonlimiting example and with reference to the appended FIG. 1, which shows diagrammatically some components of a radio terminal.

The method according to the invention consists in enabling the user of a radio terminal to send an SMS message easily to a recipient that the user chooses from call numbers offered to the user in the form of a short ordered list.

These are not numbers stored in the directory of the terminal, but the numbers of the last few callers and the last few numbers called, which are stored automatically in the terminal without intervention by the user. These numbers stored by the terminal are shown to the user on the screen of his radio terminal, in the form of an ordered “first in, first out” list. In other words, the oldest number disappears from the list when a new call is sent or received, to make room for the number corresponding to the new call.

When radio communication is in progress, the recipient of the SMS message can be the person with whom the user is in radio communication, whether he is the calling or called party.

If no radio communication is set up, the recipient of the SMS message can be the last caller (or one of the last few callers) to whom the user has been unable to respond (for example because he is in a meeting) or the last number called (or one of the last few numbers called), which has not answered either.

The steps for sending the SMS message include one of specifying the address of the recipient of the message, consisting of the number of the radio terminal of the recipient. The user having entered the text of the message, either before or after entering the address, the whole of the message comprising the text and the information necessary for sending an SMS message can be sent.

Of more particular relevance here is the step of specifying the number of the radio terminal of the recipient and then copying it into the address field.

According to the invention, the number of the recipient is chosen by the user from an ordered list displayed by the terminal. The first recipient terminal number in the ordered list is preferably:

that of a terminal with which the first terminal is in radio communication,

that of the last caller if said first terminal is not in radio communication.

Copying the number chosen in this way into the address field of the SMS message can be commanded by the user or systematically, i.e. by default.

If no SMS message is finally sent, the number copied by default into the address field can be overwritten by the next number. This default option is determined by one of the configuration parameters of the radio terminal, for example. The user then configures this parameter via a menu for this command.

In a first embodiment, the user chooses the number of the radio terminal of the recipient by means of a menu that is displayed when the command “send to” is selected. That menu lists, for example:

a single recipient

a plurality of recipients

a recipient from the directory

one of the last few callers or his name or his number

one of the last few called parties or his name or his number.

The latter two lists are preferable replaced in this menu by a single ordered list “one of the last few callers or called parties”, combining the last few persons called and the last few calling parties. This list preferably includes, at the beginning:

the number of a terminal in radio communication with the first terminal,

that of the last caller if said first terminal is not in radio communication.

It continues with the other callers in decreasing date order, for example, then indicates the last called party, and finishes with the other called parties in decreasing date order.

If the user chooses the menu option “one of the last few callers or called parties”, the corresponding list is displayed and he scrolls through it to select a number. The number he wishes to call is frequently that placed automatically at the start of the list, and consequently the choice is very fast. If the user wishes to select a different number, he scrolls through the remainder of the list, but the choice is still much faster than scrolling through the whole directory of the terminal, since the list is short.

In a different embodiment, the list can further include one of the last few SMS message recipient numbers.

Two situations arise according to whether the selected number is that of a calling party or a called party.

If the number selected is that of the last called party, that number is already in memory, since the user entered it either directly or indirectly, for example from the directory. It is stored by the radio terminal in a predetermined memory area of the terminal. The user choosing a number in the “one of the last few callers or called parties” list then commands by default the copying of the number from this memory area into the address field of the SMS message.

If the number selected is that of the last calling party (or one of the last few calling parties), it is also stored by the terminal in a predetermined memory area. The user choosing the “last calling party” (or one of the last few calling parties) then commands by default the copying of the number from this memory area into the address field of the SMS message.

Once the message has been completed, since the address field is filled in, the user can send it to the recipient, for example by means of the “confirm sending” command.

In some cases, the number of the caller is not stored by the radio terminal because it is not transmitted for reasons of confidentiality, and copying the number into the address field is then impossible. The user may not have noticed that the number of the caller has not been shown to him. A visual and/or audible signal can then indicate that it is impossible to copy the number into the address field.

In a preferred embodiment of the invention, as soon as radio communication is initialized, activation by the user of the “send to” command causes a “send an SMS message to one of the last few callers or called parties” command to appear directly without it being necessary to scroll through the commands in a menu. Thus the user can access this command faster. It can be offered in the form of an icon, in particular.

If the user activates this command, the terminal displays the ordered list described above.

There are several embodiments of a radio terminal. FIG. 1 shows one by way of example: this radio terminal 1 includes an SIM module 2, of course, a central unit 3, a program memory 4, a working memory 5, a storage memory 6, and means for sending an SMS message that includes in particular an address field 7, a text field 8 and other fields for information specific to an SMS message. The above components are interconnected by a bus 9.

The SIM module includes in particular one or more memories 10 for temporarily storing the last numbers. These last caller and/or called party numbers can also be stored in the memory 6.

The program for sending SMS messages stored in the working memory 5 includes instructions for selecting one of the numbers stored in the memory 6 and copying the selected number from the memory 6 to the address field 7 to implement the method according to the invention.

The radio terminal according to the invention can also include configuration parameters, at least one of which is dedicated to copying the number into the address field, and means for configuring said parameter for the purposes of said copying.

1. A method of sending a message, such as an SMS message comprising an address field, from a first radio terminal to a recipient radio terminal, the address field of said SMS message being filled in with the number of the recipient terminal, which method is characterized in that the first terminal automatically prompts its user to choose said recipient terminal number from an ordered list of numbers stored automatically in the first terminal, said stored numbers consisting of the numbers of the last few caller and/or called terminals, and in that the recipient terminal number is chosen from the ordered list by a user of said first terminal using said control means.

2. A method according to claim 1 characterized in that the first recipient terminal number in the ordered list is that of a terminal with which the first terminal is in radio communication.

3. A radio terminal (1) including means for sending an SMS message comprising an address field (7) and at least one memory area (6 or 10) adapted to store the numbers of the last few caller and/or called radio terminals, which terminal is characterized in that said means for sending an SMS message include:
means for ordering a list of recipient terminal numbers from numbers stored automatically in said memory area,
means for prompting its user to choose said recipient terminal number from said ordered list, and
means for commanding the copying of the selected number from said memory area (6 or 10) into said address field (7).

4. A radio terminal according to claim 3, characterized in that it includes configuration parameters, at least one of which is dedicated to copying the number into the address field, and means for configuring said parameter with a view to said copying.
